(19) United States
(12) Patent Application Publication
(10) Pub. No.: US 2004/0125715 A1
(43) Pub. Date: Jul. 1, 2004

(54) Method and system for searching and recording in optical recording medium

(75) Inventors: Ming-Hung Lee, Hsin-Chu City (TW); Yuan-Ting Wu, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/623,602

(22) Filed: Jul. 22, 2003

(30) Foreign Application Priority Data
Sep. 2, 2002 (TW) 091119915

(51) Int. Cl. G11B 7/00

(52) U.S. Cl. 369/47.14; 369/53.17

(57) ABSTRACT

The invention provides a searching and recording method to search a corresponding replacement block for a defect block to correctly record digital data onto an optical recording medium. When the digital data which is designated to be recorded in a predetermined block in a data area of a target data management area (DMA) is determined to be recorded in another block, inspect the detect table to find an idle recording entry in a target detect table block (DTB) corresponding to the target DMA for recording. If no spared entry in the corresponding target DTB, sequentially leapfrog around the target DTB back and forth to search in the adjacent DTB for any idle entry. Record the digital data in a replacement block corresponding to the entry in the spare area of a DMA corresponding to the searched DTB.

### BACKGROUND OF THE INVENTION

1. Field of the Invention

The present invention relates to a searching and recording method and system, especially to a method and a system to correctly record digital data onto an optical recording medium.

2. Description of the Prior Art

Conventionally, a compact disk (CD) has a defect table (DT). When an optical recording/reading device records or reads a defect block in the CD, the DT enables the optical recording/reading device to search for a replacement block in the CD.

Please referring to FIG. 1, FIG. 1 is a schematic diagram for file arrangement in a completely formatted CD 10 according to the prior art. The CD 10 comprises at most 64 defect management areas (DMA) sequentially arranged in the middle part 16 of the CD 10. The CD 10 also comprises a main detect table (MDT) and a second defect table (SDT) respectively stored in the lead-in area 12 in the inner part of the CD 10 and the program area 14 in the outer part of the CD 10.

Each of the DMAs comprises a data area (DA) and a spare area (SA), so that the CD 10 comprises respectively at most 64 DAs and corresponding SAs. In the prior art, the DA comprises 4352 blocks to record digital data. The SA comprises 256 blocks spared for recording digital data when the DA's block is defective. Each of the blocks is coded with a corresponding address for identification purpose.

The SDT duplicates from the MDT. In following description and explanation, both SDT and MDT are called as DT (defect table) 18. The DT 18 comprises at most eight packets 19. Each of the packets 19 comprises four sets of defect table blocks (DTB) 22, 24, 26, 28 arranged in a specific order. Each of the DTBs sets 22, 24, 26, 28 comprises eight DTBs 20. In one packet 19, data of the eight DTBs 20 are repeatedly recorded in the four DTBs sets 22, 24, 26, 28. Thus, one packet 19 records only data for 8 DTBs rather than for 32 DTBs (4×8=32). As a result, the DT 18 totally contains data for 64 DTBs (8×8=64) at most, wherein each of the 64 DTBs respectively corresponds to one of the 64 SAs in the DMA.

Each DTB 20 comprises a plurality of predetermined entries, and each of the entries corresponds to each of the 256 blocks of SA. When the digital data which is designated to be recorded in a predetermined block in a DA of a target DMA is determined to be recorded in another block, inspect whether the defect table still has an idle recording entry in a target DTB corresponding to the target DMA. In the case shown in FIG. 1, the DTB 20a is the corresponding target DTB. If there is still an idle recording entry in the corresponding target DTB 20a, record the digital data in the block corresponding to the idle recording entry in the SA of the target DMA. According to the prior art method, if there is no idle recording entry in the corresponding target DTB 20a, inspect the next target DTB 20b to see whether there is any idle recording entry can be used. If there is still no idle recording entry in the target DTB 20b, the optical recording/reading device continuously inspects the target DTB 20c next to the target DTB 20b until that an idle recording entry is found. However, in the prior art, due to the specific structure of the optical recording/reading device, the pick up head needs to move a longer distance to search, wasting a lot of time in searching.

### SUMMARY OF THE INVENTION

It is therefore a primary objective of the present invention to provide a method and a system for searching and recording digital data in an optical recording medium to solve the above mentioned problem.

In a preferred embodiment, the present invention provides a method to search a corresponding replacement block for a defect block in an optical recording medium, so as to correctly record digital data onto the optical recording medium. The method can be applied by a replacement determination module. The optical recording medium comprises a plurality of sequentially arranged defect management areas (DMA). Each DMA comprises a data area (DA) and a spare area (SA). Both of the DA and SA comprise a plurality of blocks for recording digital data. Each block is coded with a corresponding address for identification. The optical recording medium further comprises a defect table. The defect table comprises a plurality of defect table blocks (DTB). Each DTB corresponds to one of the DMA and comprises a plurality of predetermined recording entries for one to one corresponding to the blocks of the SA.

When the replacement determination module determines that the digital data which is designated to be recorded in a predetermined block in a DA of a target DMA must be recorded in another block, the module inspects whether the defect table has an idle recording entry available in DTB corresponding to the target DMA. If there is no idle recording entry in the corresponding target DTB, the target DTB will be used as the center, and the replacement determination module sequentially leapfrogs around the target DTB back and forth to search in the adjacent DTB until finding out a replaced DTB with any idle recording entry for replacement. Finally, the replacement determination module will record the digital data in a replacement block corresponding to the idle recording entry in the SA of the DMA which corresponds to the searched replacement DTB.

The present invention provides a method for searching and recording in an optical recording medium. The target DTB will be the center which is sequentially leapfrogged around to search in the adjacent DTBs for any idle recording entry. It is an advantage of the present invention that the efficiency of digital recording/reading is improved.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram for file arrangement in a completely formatted CD according to the prior art.

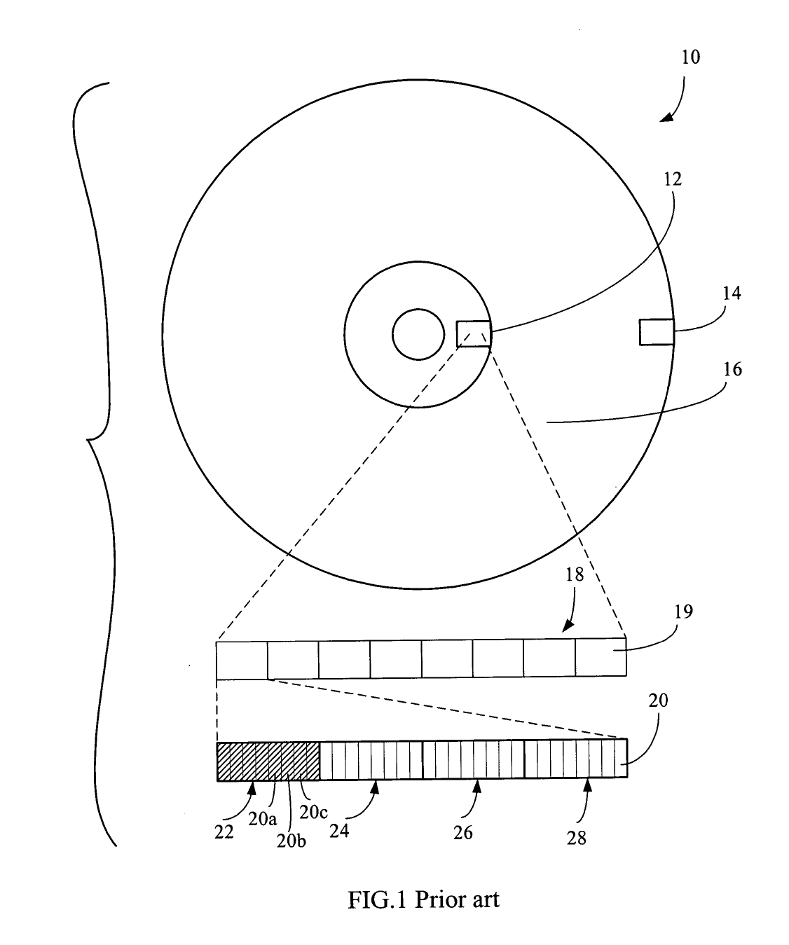

FIG. 2 is a diagram showing the method of searching and recording block in an optical recording medium according to the present invention.

FIG. 3 shows data arrangement in the recording entry of the DTB shown in FIG. 2.

FIG. 4 is the flowchart of the method for searching and recording in an optical recording medium according to the present invention.

FIG. 5 is a functional block diagram of the searching and recording system of the present invention.

### DETAILED DESCRIPTION OF THE PREFERRED EMBODIMENT

The present invention provides a method and a system to search a corresponding replacement block for a defect block in an optical recording medium, so as to correctly record digital data into the optical recording medium. The optical recording medium can be a CD-RW (Compact Disk ReWritable) or a DVD+RW (Digital Versatile Disk plus ReWritable), . . . etc.

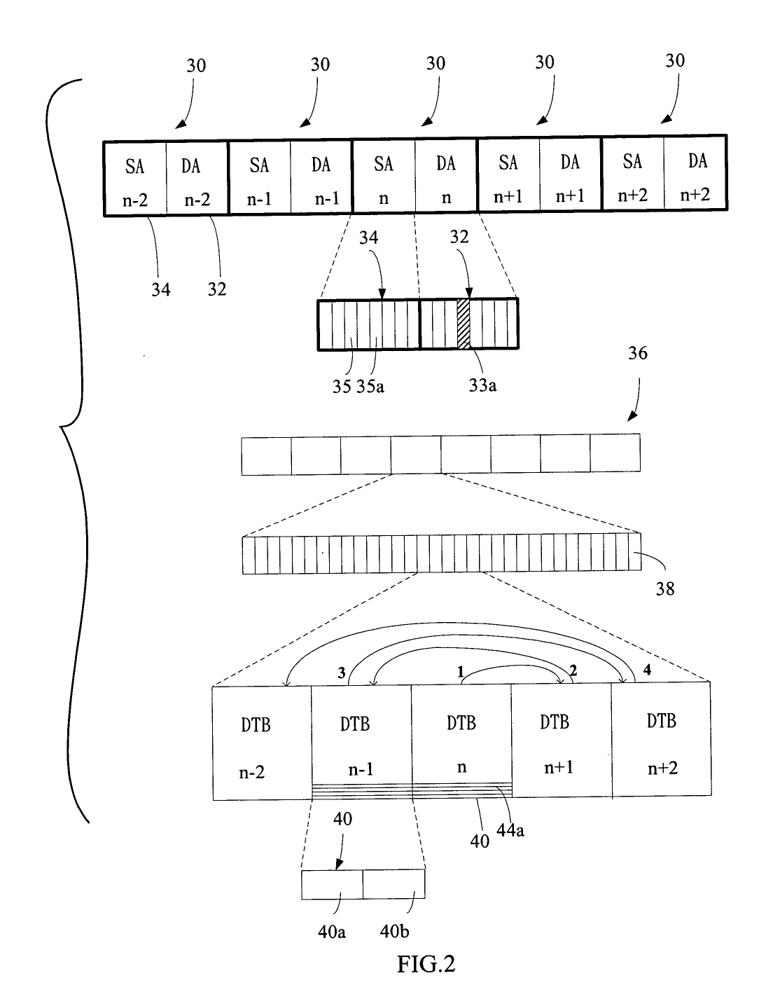

Please referring to FIG. 2, FIG. 2 is a diagram showing the method of searching and recording block in an optical recording medium according to the present invention. An optical recording medium (not shown in FIG. 2) comprises a plurality of sequentially arranged defect management areas (DMA) 30. Each of the DMAs 30 comprises a data area (DA) 32 and a spare area (SA) 34. Both of the DA 32 and SA 34 comprise a plurality of blocks 35 for recording digital data. Each of the blocks 35 is coded with a corresponding address for identification purpose.

The optical recording medium further comprises a defect table 36. The defect table 36 has a plurality of defect table blocks (DTBs) 38 sequentially arranged. Each of the DTBs 38 corresponds to the SA 34 in the DMA 30. Each of the DTBs 38 comprises a plurality of predetermined recording entries 40. Each of the recording entries 40 in each DTB 38 corresponds one by one to each of the blocks 35 of each SA 34.

Each recording entry 40 is divided into unit 40a and unit 40b. The unit 40a is used to record the corresponding address of the defect block 33a in the DA 32. The unit 40b is used to record the corresponding address of the SA 34.

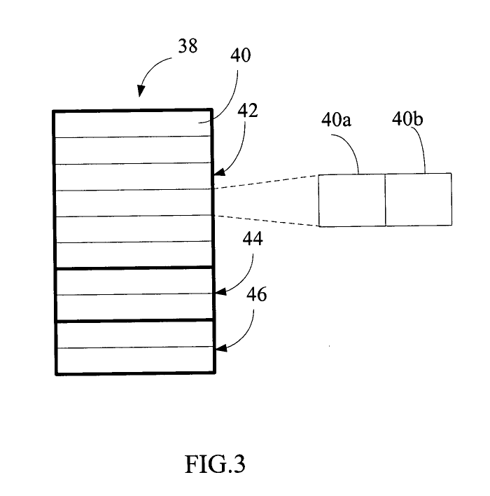

Please referring to FIG. 3, FIG. 3 shows data arrangement in the recording entry 40 of the DTB 38 shown in FIG. 2. There are three kinds of areas in each DTB 38 according to the recording status of the block 35 in the corresponding SA 34 of recording entry 40. The first is the used recording entry area 42, meaning that the replacement block 35 corresponding to the recording entry has replaced the block indicated by the unit 40a to be recorded with digital data. The second is the usable-but-idle recording entry area 44, meaning that the corresponding replacement block 35 has not been recorded with digital data. The third is the unusable recording entry area 46, meaning that the corresponding replacement block 35 can not be used for recording digital data. Therefore, searching whether the DTB 38 still has any usable-but-idle recording entry area 44 will know that whether there is still any idle replacement block 35 in the SA 34 for recording digital data.

The process of recording a digital data in an optical recording medium is to record the digital data in a predetermined block in the DA 32 of a target DMA 30. When the predetermined block is defective, cannot record data or cannot be correctly read after recording, a replacement determination module (not shown in FIG. 2 or FIG. 3) will determine that the digital data should be recorded in another block.

As shown in FIG. 2, the block 33a in the DA n of the target DMA is used as the predetermined block to record data. If a digital data is designated to be recorded in the block 33a, but the block 33a is defective; or if an abnormal operation occurs while reading the digital data which has been recorded in the block 33a, the replacement determination module determines that the digital data has to be recorded in another block of the SA 34.

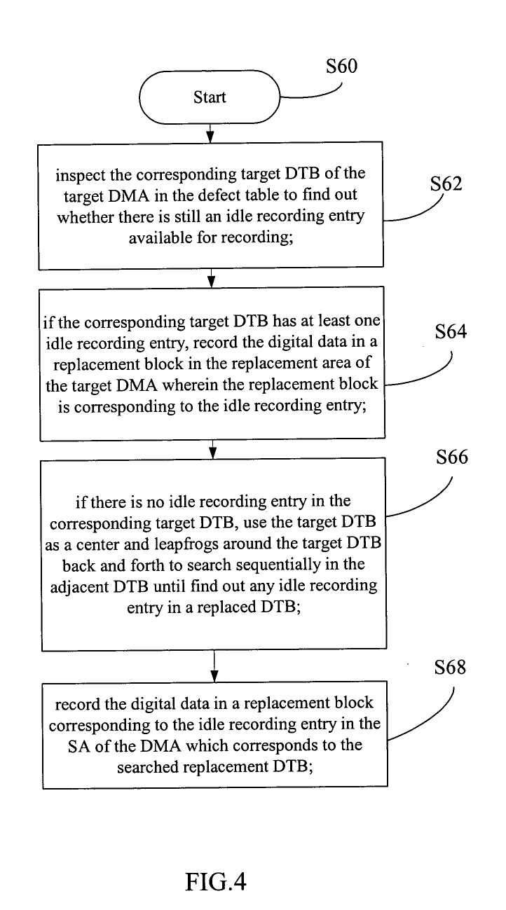

Please referring to FIG. 4, FIG. 4 is the flowchart of the method for searching and recording in an optical recording medium according to the present invention. Also refer to FIG. 2. When a digital data which is designated to be recorded in a predetermined block 33a in the DA n of the target DMA n, but the replacement determination module determines that the digital data must be recorded in the another block of SA 34, the searching and recording method of the present invention is applied. The searching and recording method of the present invention comprises the following steps:

Step S60: Start.

Step S62: Inspect the corresponding target DTB n of the target DMA in the detect table 36 to find out whether there is still an idle recording entry 44a available for recording.

Step S64: If the corresponding target DTB has at least one idle recording entry 44a, record the digital data in a replacement block 35a in the replacement area n of the target DMA wherein the replacement block 35a is corresponding to the idle recording entry.

Step S66: If there is no idle recording entry 44 in the corresponding target DTB, use the target DTB as the center and leapfrogs around the target DTB back and forth to search sequentially in the adjacent DTB until find out any idle recording entry in a replaced DTB.

Step S68: Record the digital data in a replacement block corresponding to the idle recording entry in the SA of the DMA which corresponds to the searched replacement DTB.

Please referring to FIG. 2, in this embodiment, the block 33a in the DA n is defective, the digital data which is designated to be recorded in the block 33a must be recorded in another block. Inspect the DTB n in the defect table 36 to see whether there is still an idle recording entry 44a available for recording. If DTB n at least has one idle recording entry 44a, record the digital data in a replacement block 35a corresponding to the idle recording entry 44a in the SA n.

If there is no idle recording entry in the DTB n, use the DTB n as the center and sequentially leapfrogs around the DTB n back and forth to search in the adjacent DTB for any idle recording entry. In other words, sequentially inspect DTB n+1 according to the direction of the arrow 1 shown in FIG. 2. If there is still no idle recording entry in the DTB n+1, sequentially inspect the DTB n−1, n+2, n−2 . . . according to the directions of arrows 2,3,4, . . . until finding out any idle recording entry in a DTB. Then record the digital data in a corresponding replacement block of the idle recording entry.

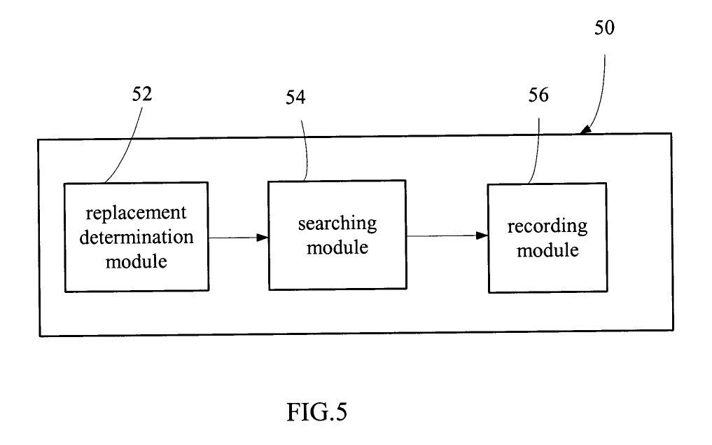

Please refer to FIG. 5, FIG. 5 is a functional block diagram of the searching and recording system 50 of the present invention. The searching and recording system 50 of the present invention can be a CD player. The CD player comprises a replacement determination module 52, a searching module 54, and a recording module 56. The replacement determination module 52 is used for determining whether the digital data which is designated to be recorded in a predetermined block in a DA n of a DMA 30 should be recorded in another block. When the replacement determination module 52 determines that the digital data should be recorded in another block, the searching module 54 will inspect whether there is still an idle recording entry in a target DTB n corresponding to the target DMA n in the defect table 36. If there is still an idle recording entry 44a in the DTB n, the recording module 56 records the digital data in a corresponding replacement block of the recording entry 44a.

If there is no idle recording entry in the DTB n, the DTB n will be the center and the searching module 54 sequentially leapfrogs around the DTB n back and forth to search in the adjacent DTBs n+1, n−1, n+2, n−2, and so on (see FIG. 2) for any idle recording entry available for replacement until finding out any idle recording entry of a replaced DTB. In this way, when there is no idle recording entry in DTB n+1, the present invention method searches in DTB n−1, comparing to the prior art to search in DTB n+2. The distance between DTB n and DTB n−1 is shorter than the distance between DTB n and DTB n+2. In other words, the distance between the defect block corresponding to DTB n and the replacement block corresponding to DTB n−1 is shorter than the distance between the defect block corresponding to DTB n and the replacement block corresponding to DTB n+2. As a result, the time for the CD player to write the replacement block or to read the replacement block later on are shorter than that for the prior art. The more the defect blocks are, the more time are relatively saved for the present invention, comparing to the prior art.

The present invention provides a method for searching and recording in an optical recording medium. The target DTB will be the center to be sequentially leapfrogged around to search in the adjacent DTBs for any idle recording entry. It is an advantage of the present invention that the efficiency of digital reading and recording is improved because the replacement blocks distribute very closely.

With the embodiment and explanations above, the features and spirits of the invention will be hopefully well described. Those skilled in the art will readily observe that numerous modifications and alterations of the device may be made while retaining the teaching of the invention. Alternatively, the above disclosure should be construed as limited only by the metes and bounds of the appended claims.

What is claimed is:

1. A searching and recording method to search a corresponding replacement block for a defect block in an optical recording medium, so as to correctly record digital data onto said optical recording medium, the optical recording medium comprising a plurality of sequentially arranged defect management areas (DMAs), each DMA having a data area (DA) and a spare area (SA), both of said DA and SA comprising a plurality of blocks for recording digital data, each said block being coded with a corresponding address for identification, and said optical recording medium further comprising a defect table, which has a plurality of defect table blocks (DTB), each said DTB corresponding to one of said DMA in said optical record medium and comprising a plurality of predetermined recording entries corresponding one by one to the blocks of said SA, said searching and recording method comprising the following steps:
in said optical record medium, when the digital data, which are designated to record on a predetermined block in the DA of a target DMA, are determined to be recorded on another block, inspecting whether a target DTB corresponding to the target DMA still has an idle recording entry;
if there is no idle recording entry in said target DTB, searching said DTBs adjacent to said target DTB for any said idle recording entry by sequentially leapfrogging around said target DTB back and forth; and
when said idle recording entry is searched in a replacement DTB, recording the digital data in a replacement block corresponding to said idle recording entry, wherein said replacement block is in the SA corresponding to said replacement DTB.

2. The searching and recording method of claim 1, wherein if there is at least one idle recording entry in the corresponding target DTB, record the digital data in a replacement block corresponding to said idle recording entry in the SA of said target DMA.

3. The searching and recording method of claim 1, wherein a replacement determination module is used for determining whether the digital data should be recorded in another block.

4. The searching and recording method of claim 3, wherein if the digital data is designated to be recorded in the predetermined block of said optical record medium but the predetermined block contains defect, the replacement determination module determines that the digital data has to be recorded in another block.

5. The searching and recording method of claim 3, wherein if an abnormal operation occurs while reading the digital data from said optical record medium, the replacement determination module will determine that the digital data has to be recorded in another block.

6. The searching and recording method of claim 1, wherein the optical recording medium is a CD-RW (Compact Disk ReWritable).

7. The searching and recording method of claim 1, wherein the optical recording medium is a DVD+RW (Digital Versatile Disk plus ReWritable).

8. A searching and recording system to search a corresponding replacement block for a defect block in an optical recording medium, so as to correctly record digital data onto said optical recording medium, the optical recording medium comprising a plurality of sequentially arranged defect management areas (DMA), each DMA having a data area (DA) and a spare area (SA), both of said DA and SA comprising a plurality of blocks for recording digital data, each said block being coded with a corresponding address for identification, said optical recording medium further comprising a defect table, which has a plurality of defect table blocks (DTB), each said DTB corresponding to one of said DMA in said optical record medium, which comprising a plurality of predetermined recording entries corresponding one by one to the blocks of said SA, said searching and recording system comprising:
a replacement determination module determining whether the digital data which are designated to record on a predetermined block in a DA of a target DMA should be recorded in another block;
a searching module inspecting whether the defect table still has an idle recording entry in a target DTB corresponding to the target DMA when the replacement determination module determines the digital data to be recorded in another block;
a recording module, recording the digital data in a replacement block corresponding to said idle recording entry in the SA of said target DMA if there is at least one idle recording entry in the corresponding target DTB;
wherein if there is no idle recording entry in said corresponding target DTB, the searching module sequentially leapfrogs around said target DTB back and forth to search for any idle recording entry in the adjacent DTB for replacement; wherein until a replacement DTB containing any idle recording entry is searched, the record module records the digital data in a replacement block corresponding to said idle recording entry in the SA of the DMA which corresponds to the searched replacement DTB.

9. The searching and recording system of claim 8, wherein if the digital data is designated to be recorded in the predetermined block of said optical record medium but the predetermined block contains defect, the replacement determination module determines that the digital data has to be recorded in another block.

10. The searching and recording system of claim 8, wherein if an abnormal operation occurs while reading the digital data from said optical record medium, the replacement determination module will determine the digital data has to be recorded in another block.

11. The searching and recording system of claim 8, wherein the optical recording medium is a CD-RW (Compact Disk ReWritable).

12. The searching and recording system of claim 8, wherein the optical recording medium is a DVD+RW (Digital Versatile Disk plus ReWritable).
